(19) United States
(12) Patent Application Publication
(10) Pub. No.: US 2021/0116564 A1
(43) Pub. Date: Apr. 22, 2021

(54) VOLTAGE GENERATION IN LIGHT DETECTION AND RANGING (LIDAR) SYSTEM

(71) Applicant: DiDi Research America, LLC, Mountain View, CA (US)

(72) Inventors: Yue Lu, Mountain View, CA (US); Yibo Yu, Mountain View, CA (US); Lingkai Kong, Mountain View, CA (US); Chao Wang, Mountain View, CA (US); Youmin Wang, Mountain View, CA (US)

(73) Assignee: DiDi Research America, LLC, Mountain View, CA (US)

(21) Appl. No.: 16/657,997

(22) Filed: Oct. 18, 2019

(51) Int. Cl. G01S 17/10; G01S 7/34

(52) U.S. Cl. CPC G01S 17/105; G01S 7/497; G01S 7/34

(57) ABSTRACT

A voltage generator supplies a voltage to an electronic device of a Light Detection and Ranging (LiDAR) system. The voltage generator includes a clock source configured to generate a clock signal and a voltage source configured to generate a first voltage signal having a first voltage level. The voltage generator also includes a voltage multiplier coupled to the voltage source and the clock source. The voltage multiplier is configured to generate a second voltage signal having a second voltage level based on the first voltage signal and the clock signal. The second voltage level is higher than the first voltage level.

### TECHNICAL FIELD

The present disclosure relates to a Light Detection and Ranging (LiDAR) system, and more particularly to, voltage generators and methods for supplying voltages to one or more electronic devices of the LiDAR system.

### BACKGROUND

LiDAR systems have been widely used in autonomous driving and high-definition map creation. A typical LiDAR system measures the distance to a target by illuminating the target with pulsed laser light using a scanner and detecting the reflected light pulses with a photodetector. Differences in light return times and wavelengths can then be used to calculate the distance to the target. The distance, coupled with known information such as the direction of the light and the location of the scanner, can be used to make digital three-dimensional (3D) representations of the target (e.g., a point cloud). The laser light used for LiDAR scan may be ultraviolet, visible, or near infrared. In a typical LiDAR system, a narrow laser beam is used as the incident light to map physical features, which can achieve a very high resolution. Such a LiDAR system is particularly suitable for applications such as high-definition map surveys and 3D sensing in autonomous driving.

In a LiDAR system, various electronic devices require low noise, high voltage power supplies. For example, high sensitivity photodetectors for detecting the reflected light pulses require a low noise bias voltage up to +/− several hundreds of volts. Generating such a high voltage from a low voltage input is challenging. Conventional approaches using boost or flyback switching DC-DC converters generally require inductors and/or transformers along with a high-performance IC to facilitate the required switching operations. Due to the use of electromagnetic components (e.g., inductors, transformers, etc.) and fast current switching devices, such conventional voltage generation circuitries tend to generate high electromagnetic interferences (EMI) that would degrade the sensitivity of the photodetectors. In addition, conventional voltage generation schemes suffer from a low conversion efficiency (typically <10%) due to a low load current (e.g., the bias current of a typical photodetector is usually less than 0.5 mA). With low conversion efficiencies, excessive heat would be generated that would further degrade the performance of the photodetectors. Moreover, the overall bill of materials (BOM) is usually quite high (estimated>$10) due to the high cost of the electromagnetic components and high-performance switching devices.

Embodiments of the disclosure address the above problems by improved voltage generators having low noise and high efficiency without using any inductors or transformers.

### SUMMARY

Embodiments of the disclosure provide a voltage generator for supplying a voltage to an electronic device of a LiDAR system. The voltage generator includes a clock source configured to generate a clock signal and a voltage source configured to generate a first voltage signal having a first voltage level. The voltage generator also includes a voltage multiplier coupled to the voltage source and the clock source. The voltage multiplier is configured to generate a second voltage signal having a second voltage level based on the first voltage signal and the clock signal. The second voltage level is higher than the first voltage level.

Embodiments of the disclosure also provide a method for generating a voltage to power an electronic device of a LiDAR system. The method includes generating, by a clock source, a clock signal. The method also includes generating, by a voltage source, a first voltage signal having a first voltage level. The method further includes generating, by a voltage multiplier, a second voltage signal having a second voltage level based on the first voltage signal and the clock signal. The second voltage level is higher than the first voltage level.

Embodiments of the disclosure further provide a LiDAR system. The LiDAR system includes a light source configured to emit a light beam, a scanner configured to project the light beam to an object, and a photodetector configured to detect a reflected light beam reflected from the objected. The LiDAR system also includes a voltage generator configured to supply a voltage to at least one of the light source, the scanner, or the photodetector. The voltage generator includes a clock source configured to generate a clock signal and a voltage source configured to generate a first voltage signal having a first voltage level. The voltage generator also includes a voltage multiplier coupled to the voltage source and the clock source. The voltage multiplier is configured to generate a second voltage signal having a second voltage level based on the first voltage signal and the clock signal. The second voltage level is higher than the first voltage level. The voltage multiplier is also configured to supply the second voltage signal to at least one of the light source, the scanner, or the photodetector.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary vehicle equipped with a LiDAR system, according to embodiments of the disclosure.

FIG. 2 illustrates a block diagram of an exemplary LiDAR system using an improved voltage generator, according to embodiments of the disclosure.

FIG. 3 illustrates a block diagram of an exemplary voltage generator, according to embodiments of the disclosure.

FIG. 4 illustrates a block diagram of an exemplary implementation of the voltage generator shown in FIG. 3, according to embodiments of the disclosure.

FIGS. 5A-5B illustrate a flowchart of an exemplary method for generating a voltage to power an electronic device of a LiDAR system, according to embodiments of the disclosure.

FIG. 6 illustrates a traditional voltage generation circuit using a transformer and a switching IC.

FIG. 7 illustrates typical efficiency v. output current curves of the traditional voltage generation circuit shown in FIG. 6.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

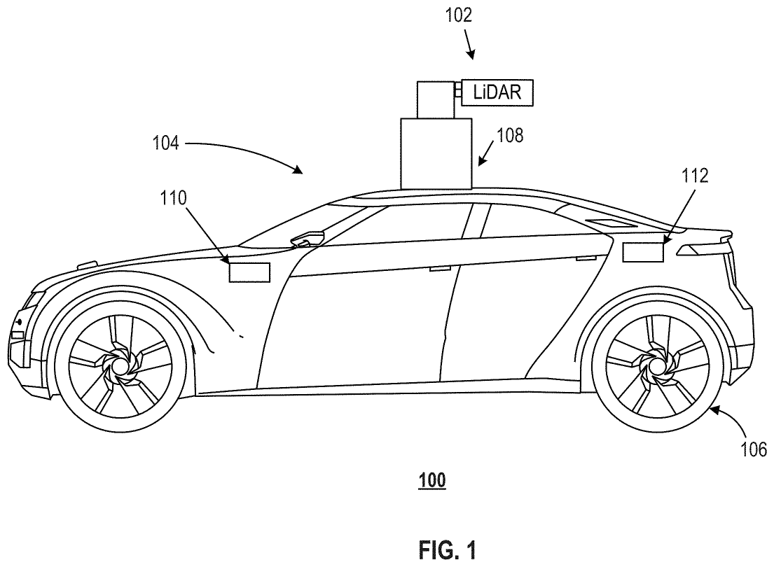

FIG. 1 illustrates a schematic diagram of an exemplary vehicle 100 equipped with a LiDAR system 102, according to embodiments of the disclosure. Consistent with some embodiments, vehicle 100 may be a survey vehicle configured for acquiring data for constructing a high-definition map or conducting city modeling. In some embodiments, vehicle 100 may be an autonomous driving vehicle capable of traveling by itself based on sensor data with little or no human intervention. It is contemplated that vehicle 100 may be an electric vehicle, a fuel cell vehicle, a hybrid vehicle, or a conventional internal combustion engine vehicle. Vehicle 100 may have a body 104 and at least one wheel 106. Body 104 may be of any body style, such as a sports vehicle, a coupe, a sedan, a pick-up truck, a station wagon, a sports utility vehicle (SUV), a minivan, or a conversion van. In some embodiments of the present disclosure, vehicle 100 may include a pair of front wheels and a pair of rear wheels, as illustrated in FIG. 1. However, it is contemplated that vehicle 100 may have less wheels or equivalent structures that enable vehicle 100 to move around. Vehicle 100 may be configured to be all wheel drive (AWD), front wheel drive (FWR), or rear wheel drive (RWD). In some embodiments of the present disclosure, vehicle 100 may be configured to be operated by an operator occupying the vehicle, remotely controlled, and/or autonomous.

As illustrated in FIG. 1, vehicle 100 may be equipped with LiDAR system 102 mounted to body 104 via a mounting structure 108. Mounting structure 108 may be an electro-mechanical device installed or otherwise attached to body 104 of vehicle 100. In some embodiments of the present disclosure, mounting structure 108 may use screws, adhesives, or other mounting mechanisms. Vehicle 100 may be additionally equipped with a sensor 110 inside or outside body 104 using any suitable mounting mechanisms. It is contemplated that the manners in which LiDAR system 102 or sensor 110 can be equipped on vehicle 100 are not limited by the example shown in FIG. 1 and may be modified depending on the types of LiDAR system 102, sensor 110, and/or vehicle 100 to achieve desirable 3D sensing performance.

Consistent with some embodiments, LiDAR system 102 and sensor 110 may be configured to capture data as vehicle 100 moves along a trajectory. For example, a scanner of LiDAR system 102 is configured to scan the surrounding area of vehicle 100 to acquire data for constructing 3D representations of objects in the surrounding area. For example, LiDAR system 102 can measure the distance to a target by illuminating the target with pulsed laser light using the scanner and detecting the reflected pulses with a photodetector. Differences in light return times and wavelengths can then be used to calculate the distance to the target. The distance, coupled with known information such as the direction of the light and the location of the scanner, can be used to make digital 3D representations of the target. The laser light used for LiDAR system 102 may be ultraviolet, visible, or near infrared. In some embodiments of the present disclosure, LiDAR system 102 may capture point clouds as a form of the digital 3D representations. As vehicle 100 moves along the trajectory, LiDAR system 102 may continuously capture data. Each set of data captured at a certain time range is known as a data frame.

As illustrated in FIG. 1, vehicle 100 may be additionally equipped with sensor 110, which may include sensors used in a navigation unit, such as a Global Positioning System (GPS) receiver and one or more Inertial Measurement Unit (IMU) sensors. By combining the GPS receiver and the IMU sensor, sensor 110 can provide real-time pose information of vehicle 100 as it travels, including the positions and orientations (e.g., Euler angles) of vehicle 100 at each time point. Pose information may be used for calibration and/or pretreatment of the point cloud data captured by LiDAR system 102.

Consistent with the present disclosure, vehicle 100 may include a local inside body 104 of vehicle 100. Controller 112 may communicate with a remote computing device, such as a server, (not illustrated in FIG. 1). Controller 112 may be configured to control the operations of LiDAR system 102 and/or sensor 110. In some embodiments, controller 112 may have different modules in a single device, such as an integrated circuit (IC) chip (implemented as an application-specific integrated circuit (ASIC) or a field-programmable gate array (FPGA)), or separate devices with dedicated functions. In some embodiments, one or more components of controller 112 may be located inside vehicle 100 or may be alternatively in a mobile device, in the cloud, or another remote location. Components of controller 112 may be in an integrated device or distributed at different locations but communicate with each other through a network (not shown).

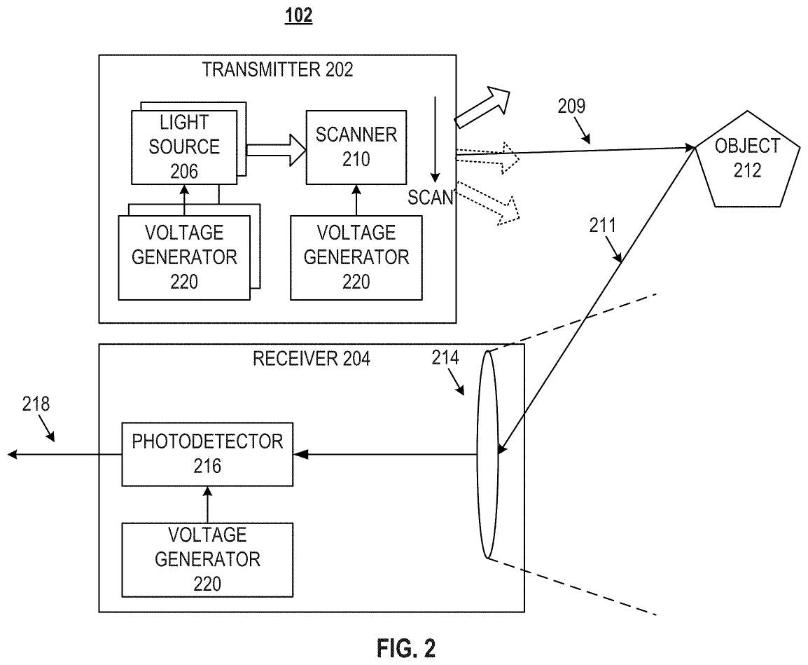

FIG. 2 illustrates a block diagram of an exemplary implementation of LiDAR system 102, according to embodiments of the disclosure. LiDAR system 102 may include a transmitter 202 and a receiver 204. Transmitter 202 may emit light beams, such as pulsed laser beams, within a scan angle. Transmitter 202 may include one or more light sources 206, a scanner 210, and one or more voltage generators 220 for supplying power to light source(s) 206 and/or scanner 210. It is noted that the manner of dividing and/or sharing of voltage generator(s) among the components (e.g., an individual light source 206, scanner 210, etc.) of transmitter 202 is not limited to the example shown in FIG. 2. In some embodiments, each component may be powered by a separate voltage generator, as shown in FIG. 2. In some embodiments, multiple components may share a voltage generator.

Light source(s) 206 used in transmitter 202 may be high power, low divergence laser source(s). In some embodiments, light source(s) 206 may require a supply voltage in the range of about 10-100 volts. Voltage generator 220 connected to a light source 206 may provide the required supply voltage with low noise. For example, voltage generator 220 may supply pulsed voltage power to drive light source 206. Light source 206 may then convert the pulsed voltage power to pulsed laser beams (e.g., in the ultraviolet, visible, or near infrared wavelength range) and emit the pulsed laser beams, which may be guided to scanner 210 for projecting to an object 212.

In some embodiments of the present disclosure, light source(s) 206 may include a fiber laser. A fiber laser may be a laser device in which the active gain medium is an optical fiber doped with rare-earth elements, such as erbium (Er), ytterbium (Yb), neodymium (Nd), dysprosium (Dy), praseodymium (Pr), thulium (Tm), and holmium (Ho). A fiber laser can have a high output power and high optical gain, such as having several kilometers long active regions, because of fiber's high surface area to volume ratio, which allows efficient cooling. A fiber laser can also have high optical quality because fiber's waveguiding properties reduce or eliminate thermal distortion of the optical path, typically producing a diffraction-limited, high-quality laser beam. Depending on the doped rare-earth elements, the wavelength of a laser beam provided by a fiber laser may be above 1,100 nm, such as 1,047 nm, 1,053 nm, 1,062 nm, 1,064 nm, 1,320 nm, 1,550 nm, between 1,570 nm and 1,600 nm, or between 1,750 nm and 2,100 nm. In some embodiments, a wavelength converter may be used to convert the wavelength of the laser beam provided by a fiber laser to below 1,100 nm in order to be detected by silicon-based photodetectors.

In some embodiments of the present disclosure, light source(s) 206 may include a diode laser. A diode laser may be a semiconductor device similar to a light-emitting diode (LED) in which the laser beam is created at the diode's junction. In some embodiments of the present disclosure, a diode laser includes a PIN diode in which the active region is in the intrinsic (I) region, and the carriers (electrons and holes) are pumped into the active region from the N and P regions, respectively. Depending on the semiconductor materials, the wavelength of a laser beam provided by a diode laser may be smaller than 1,100 nm, such as 405 nm, between 445 nm and 465 nm, between 510 nm and 525 nm, 532 nm, 635 nm, between 650 nm and 660 nm, 670 nm, 760 nm, 785 nm, 808 nm, or 848 nm.

Scanner 210 may be configured to project a light beam 209 (e.g., a pulsed laser beam emitted by light source 206) to an object 212 along a projection direction. Scanner 210 may scan object 212 using multiple light beams (including light beam 209) along multiple projection directions within a scan angle and at a scan rate. Object 212 may be made of a wide range of materials including, for example, non-metallic objects, rocks, rain, chemical compounds, aerosols, clouds and even single molecules. The wavelength of light beam 209 may vary based on, for example, the composition of object 212. At each time point during the scan, scanner 210 may project a light beam (e.g., light beam 209) to object 212 along a projection direction within the scan angle. The projected light beam may also be referred to as an incident light and the corresponding projection direction may also be referred to as an incident direction. In some embodiments of the present disclosure, scanner 210 may also include optical components (e.g., lenses, mirrors, etc., not shown) that can focus the light beam emitted by light source 206 into a narrow light beam to increase the scan resolution and range.

Scanner 210 may include a scanner driver, such as a MEMS driver, to drive the optical components used for focusing the light beam emitted by light source 206. In some embodiments, the scanner driver may require a supply voltage (e.g., MEMS driver voltage) in the range of about 100-200 volts. Voltage generator 220 connected to scanner 210 may provide the required supply voltage with low noise.

When light beam 209 is projected to object 211, light beam 209 can be reflected by object 212 via backscattering, such as Rayleigh scattering, Mie scattering, Raman scattering, and fluorescence. Receiver 204 may be configured to detect a reflected light beam 211 (e.g., a reflected laser beam) reflected from object 212 along a reflection direction. Receiver 204 can then convert the optical energy of reflected light beam 211 into electrical energy and output an electrical signal 218 indicating the intensity of reflected light beam 211. In some embodiments, receiver 204 may include a lens 214 configured to collect light from a respective direction in its field of view (FOV). At each time point during the scan, a reflected light beam 211 may be collected by lens 214. Reflected light beam 211 may be reflected from object 212 and have the same wavelength as light beam 209.

In some embodiments, photodetector 216 may be a silicon-based photodetector, which includes silicon PIN photodiodes that utilize the photovoltaic effect to convert optical power into an electrical current. Silicon-based photodetector may be used to detect light beams having a wavelength below 1,100 nm. In some embodiment, photodetector 216 may be a Ge/InGaAs-based photodetector, which can detect light beams having a wavelength above 1,100 nm.

In some embodiments, photodetector 216 may require a bias voltage in the range of 100-200 volts or −100 to −200 volts. Voltage generator 220 connected to photodetector 216 may provide the required bias voltage. As used herein, positive and negative voltages are voltage values relative to the ground or neutral. The term “high voltage” refers to a high voltage difference relative to the ground/neutral. In other words, the absolute value of a voltage is used to determine whether the voltage is a high voltage. Therefore, both +200 V and −200 V may be considered as high voltages, while +100 V is lower than +200 V and −100 V is lower than −200 V. Similarly, the term “voltage level” refers to the voltage difference relative to the ground/neutral or the absolute value of a voltage. For positive voltage values, for example, +200 V has a higher voltage level than +100 V. For negative voltage values, for example, −200 V is considered to have a higher, not lower, voltage level than −100V. Voltage generator 220 may be configured to provide both positive and negative voltages to bias photodetector 216.

Voltage generators 220 connected to different components of LiDAR system 102 (e.g., light source 206, scanner 210, and photodetector 216) may be of the same kind, but configurable or programmable according to specific voltage requirements of the respective components or may be of different kinds (e.g., implemented using different components and/or circuitry). For ease of description, voltage generators are collectively denoted using reference number 220. It is understood that they may or may not be the same device.

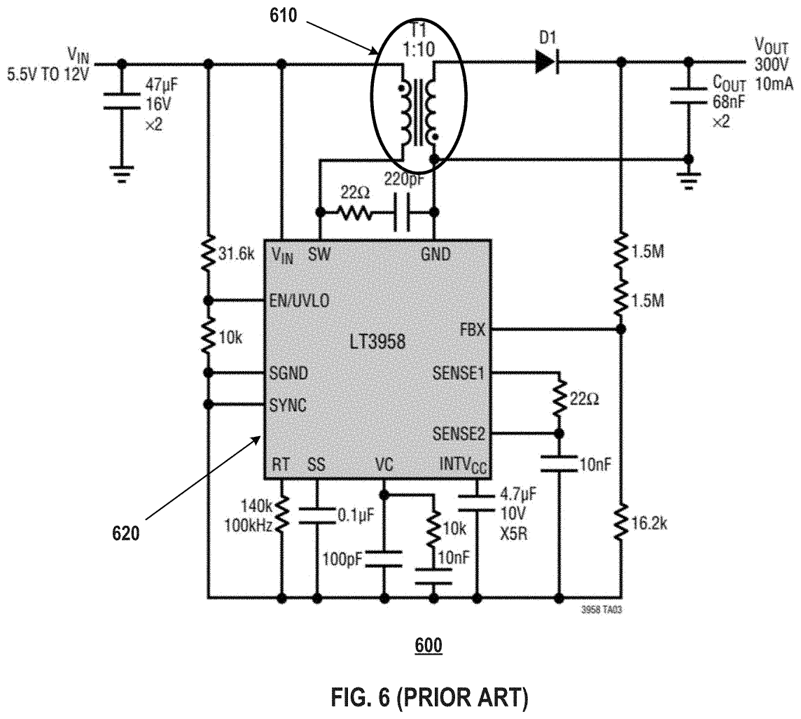

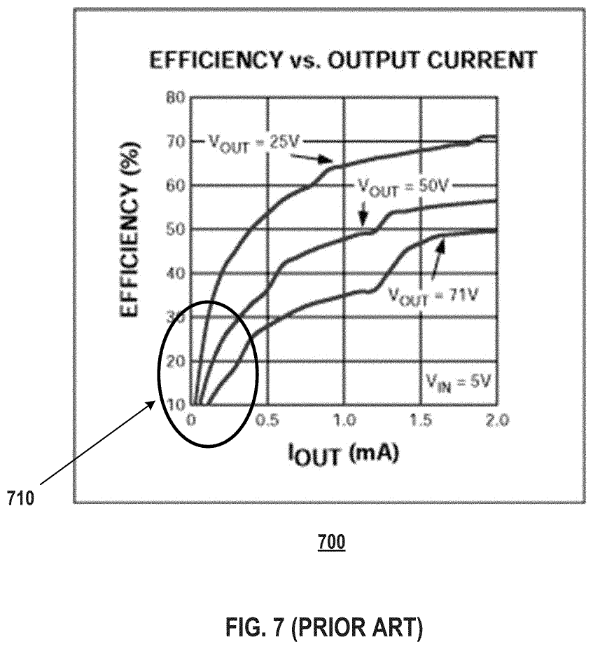

As discussed above, high voltage power supplies are required to power various components (e.g., light source 206, scanner 210, photodetector 216, etc.) of LiDAR 102. In some cases, the required voltage may range from tens of volts to hundreds of volts. Generating such a high voltage from a low voltage input is challenging. Conventional approaches using boost or flyback switching DC-DC converters generally require inductors and/or transformers along with a high-performance IC to facilitate the required switching operations. For example, FIG. 6 illustrates a traditional voltage generation circuit 600 using a transformer 610 and a switching IC 620 to implement a DC-DC converter. Transformer 610 and switching IC 620 tend to generate high EMI that would degrade the sensitivity of photodetector 216. In addition, traditional voltage generation circuit 600 suffers from a low conversion efficiency due to a low load current (e.g., the bias current of photodetector 216 is usually less than 0.5 mA). FIG. 7 illustrates typical efficiency v. output current curves 700 obtained from traditional voltage generation circuit 600. As shown in FIG. 7, the efficiencies within zone 710, where the bias current of photodetector 216 is usually located, are less than 30%. With low conversion efficiencies, excessive heat would be generated that would further degrade the performance of the photodetectors. Moreover, the overall BOM is usually quite high due to the high cost of transformer 610 and switching IC 620.

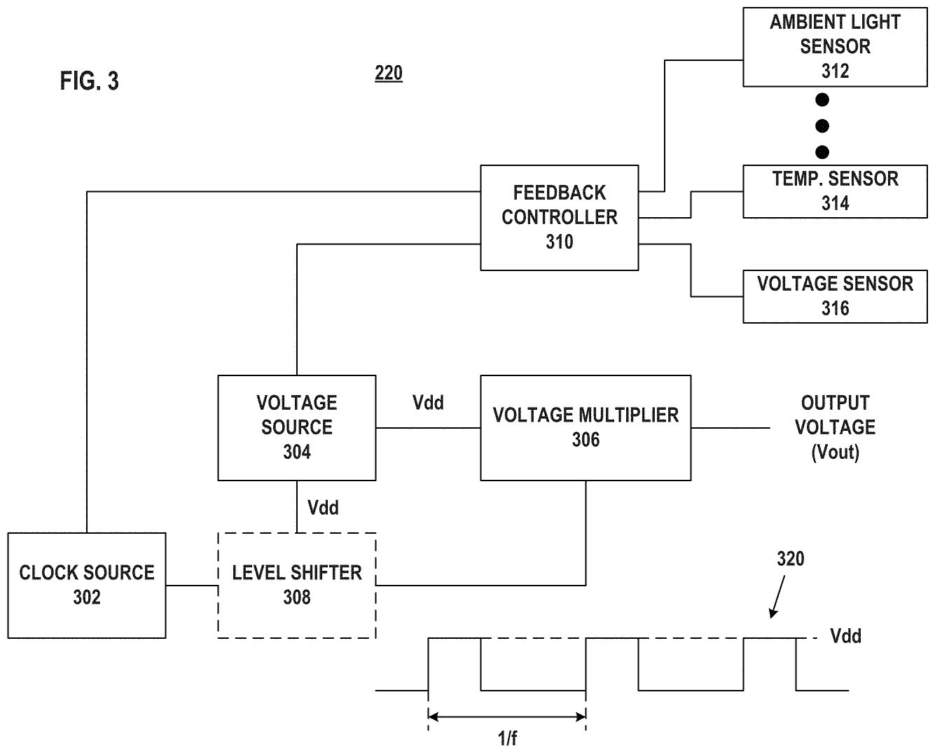

Embodiments of the present disclosure provide an improvement voltage generator 220 to address the above problems. FIG. 3 is a block diagram of an exemplary voltage generator 220, according to embodiments of the disclosure. As shown in FIG. 3, voltage generator 220 may includes a clock source 302, a voltage source 304, a voltage multiplier 306, a level shifter 308, a feedback controller 310, and one or more sensors such as ambient light sensor 312, temperature sensor 314, and voltage sensor 316. Clock source 302 may be configured to generate a clock signal. For example, the clock signal may be a periodical square wave with a frequency f and a duty cycle τ. In some embodiments, clock source 302 may be programmable to control the frequency f and/or duty cycle τ. For example, clock source 302 may be implemented using a Field-Programmable Gate Array (FPGA) or other programmable devices. In some embodiments, clock source 302 may receive a control signal from feedback controller 310 and control the frequency f and/or duty cycle τ based on the control signal.

Voltage source 304 may be configured to generate a first voltage signal having a first voltage level. For example, voltage source 304 may generate a Vdd signal (the first voltage signal) having a relatively low voltage level (the first voltage level, e.g., 1.5V, 5V, etc.). Voltage source 304 can be any suitable DC voltage source capable of generating a low-level voltage output. In some embodiments, voltage source 304 may be programmable to control the voltage level of the generated voltage signal. In some embodiments, voltage source 304 may receive a control signal from feedback controller 310 and control the voltage level of the generated voltage signal based on the control signal.

Voltage multiplier 306 may be coupled to voltage source 304 and clock source 302 (either directly or through level shifter 308), as shown in FIG. 2. Voltage multiplier 306 may receive as input the first voltage signal generated by voltage source 304 (e.g., Vdd) and the clock signal (with or without being level shifted) generated by clock source 302. Voltage multiplier 306 may be configured to generate a second voltage signal having a second voltage level based on the first voltage signal and the clock signal. For example, voltage multiplier 306 may increase the voltage level of the first voltage signal to the second voltage level to generate the second voltage signal such that the second voltage level is higher than the first voltage level. In some embodiments, the second voltage signal may be output as an output voltage to supply one or more electronic devices of LiDAR 102. In some embodiments, voltage multiplier 306 may multiply the first voltage signal by a multiplication factor to generate the second voltage signal. The multiplication factor may be based on the internal structure or configuration of voltage multiplier 306 (e.g., the number of stages or levels, to be discussed in greater detail below).

In some embodiments, clock signal generated by clock source 302 may be directly used by voltage multiplier 306. In such cases, clock source 302 may be directly coupled to voltage multiplier 306. In some embodiments, the voltage level of the clock signal may need to be shifted (e.g., increased) to, for example, Vdd before inputting to voltage multiplier 306. In such cases, level shifter 308 may be used. As shown in FIG. 3, level shifter 308 may be coupled to clock source 302, voltage source 304, and voltage multiplier 306. Level shifter 308 may receive inputs from voltage source 304 (e.g., Vdd) and clock source 302 (e.g., the clock signal), and shift the voltage level of the clock signal to Vdd based on the the first voltage signal received from voltage source 304.

Level shifter 308 may also be referred to as a logic-level shifter, and may include any suitable circuits configured to translate an input signal with one voltage level to another voltage level, for example, from an original voltage level of the clock signal to Vdd. The output voltage level (e.g., the voltage level to be shifted to) may be based on input from voltage source 304 (e.g., the first voltage level Vdd of the first voltage signal). For example, the output voltage level of level shifter 308 may track or follow the voltage level of the input from voltage source 304 such that when the voltage level of the first voltage signal changes, the output voltage level of level shifter 308 also changes accordingly. Level shift 308 may be implemented by a fixed function level shifter IC (e.g., translating an input voltage level to one or more fixed output voltage levels) or a configurable mixed-signal IC (e.g., translating an input voltage level to a configurable output voltage level, such as based on a control signal from another input). In some embodiments, level shifter 308 may be implemented using an OTS IC.

In some embodiment, the clock signal generated by clock source may include a plurality of pulses. For example, the plurality of pulses may by in the form of a square wave, a sinusoidal wave, a triangular wave, or the like. The plurality of pluses generated by clock source 302 may have an original voltage level (e.g., represented by the height of the pulses), frequency f, and duty cycle τ. Level shifter 308 may shift the height of the pulses to the first voltage level based on the input from voltage source 304. In some embodiments, level shifter may retain the frequency f and the duty cycle τ of the clock signal. FIG. 3 shows an exemplary clock signal 320 having its voltage level shifted to the first voltage level (e.g., Vdd). Level shifter 308 may supply clock signal 320 to voltage multiplier 306 to generate the second voltage signal.

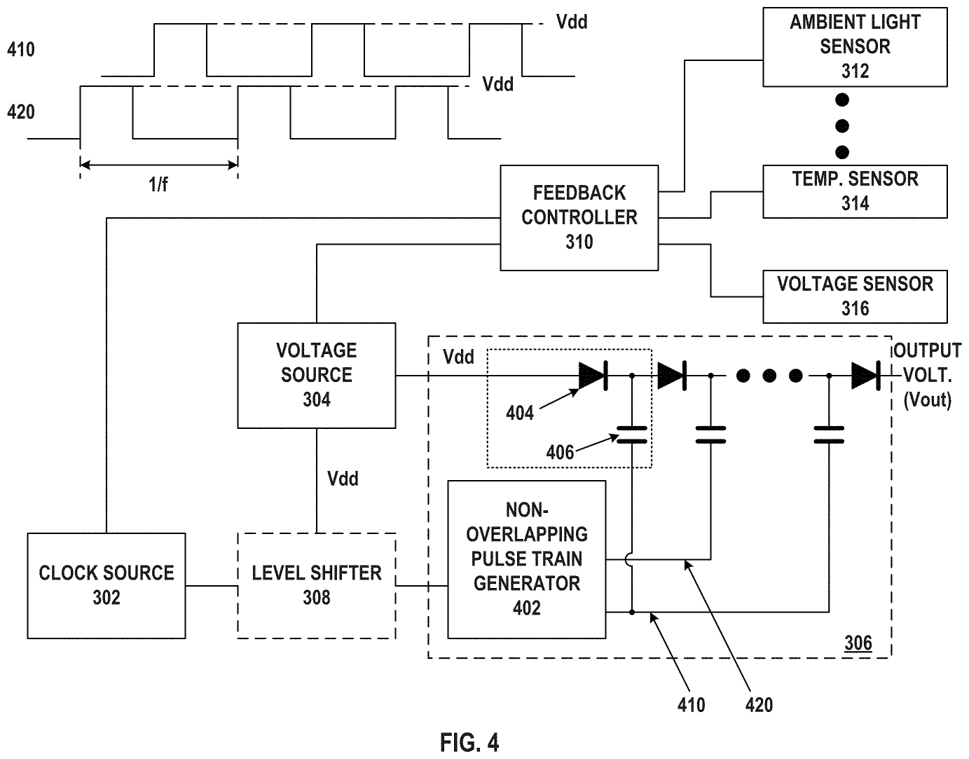

Voltage multiplier 306 may be implemented by any suitable circuits for converting a low voltage signal to a high voltage signal. FIG. 4 illustrates an exemplary implementation of voltage multiplier 306. Referring to FIG. 4, voltage multiplier 306 may be implemented by a Dickson voltage multiplier having multiple stages. Each stage may include a diode 404 and a capacitor 406. In some embodiments, a non-overlapping pulse train generator 402 may be used to generate two non-overlapping pulse trains 410 and 420 to alternately charge the capacitors of each stage such that the voltage level increases along the multiple stages until reaching the required output voltage level. As shown in FIG. 4, non-overlapping pulse train generator 402 is coupled to level shifter 308 and receive as input the clock signal having its voltage level shifted to Vdd, as discussed above. Non-overlapping pulse train generator 402 then generate two pulse trains 410 and 420, as shown in FIG. 4, which have non-overlapping pulses. Pulse trains 410 and 420 may be supplied to the Dickson voltage multiplier 306 shown in FIG. 4 to increase the voltage level. Non-overlapping pulse train generator 402 may be implemented by a two-phase NOR-flipflop based circuit that derives a two-phase clock signal from a single clock signal. Non-overlapping pulse train generator 402 may also be implemented using an OTS IC. It is noted that non-overlapping pulse trains 410 and 420 may also be generated directly by clock source 302 (e.g., when a microcontroller or FPGA is used to generate the clock signal), in which case non-overlapping pulse train generator 402 can be omitted. In addition, non-overlapping pulse trains 410 and 420 are used to charge the Dickson type voltage multiplier shown in FIG. 4. When other types of voltage multiplier are used to implement voltage multiple 306, non-overlapping pulse trains 410 and 420 may not be necessary. Therefore, non-overlapping pulse train generator 402 may be omitted in a non-Dickson type voltage multiplier.

During operation, voltage multiplier 306 may increase the voltage level along its multiple stages. For example, when pulse train 410 is low and pulse 420 is high, capacitor 406 is charged by the input voltage Vdd (provided by voltage source 304) through diode 404. Capacitor 406 may be charged to Vdd. Then, pulse train 410 becomes high and pulse train 420 becomes low. This brings the voltage level at the junction between diode 404 and capacitor 406 to 2Vdd, which then charges the capacitor of the next stage through the diode of the next stage. In this way, at each stage the voltage level is increased by Vdd. The output voltage Vout is, in theory, the number of stages N multiplied by Vdd. In practice, however, due to the voltage drop across diodes and parasitic capacitance (acting as a voltage divider together with the capacitor), the output voltage may be lower than N×Vdd. In general, the output voltage Vout is proportional to N×Vdd. Therefore, the output voltage may be controlled through Vdd (e.g., by controlling voltage source 304).

The output current Iout is proportional to Vdd×Ccp×f, where Ccp is the capacitance value used in voltage multiplier 306, and f is the frequency of the clock signal (e.g., also the frequency of pulse trains 410 and 420 in the implementation shown in FIG. 4). Therefore, the output current may be controlled through Vdd and/or f Vdd can be adjusted by controlling voltage source 304. Clock frequency f can be adjusted by controlling clock source 302.

In some embodiments, a feedback control mechanism may be used to control the output voltage Vout and/or output current Iout. The feedback control may be implemented by feedback controller 310, as shown in FIGS. 3 and 4. Feedback controller 310 may be any suitable microcontroller, microprocessor, or the like. Feedback controller 310 may receive sensing signals from one or more sensors (ambient light sensor 312, temperature sensor 314, voltage sensor 316, or the like) and generate a control signal to control voltage source 304 and/or clock source 302 based on the sensing signal. The sensors may be configured to sense an operation status or an operation environment of voltage generator 220 and generate a sensing signal to facilitate feedback control. For example, voltage sensor 316 may sense ripples or noise in the output voltage Vout. If the ripples/noise is too large (e.g., larger than a predetermined threshold), it may indicate that voltage generator 220 does not provide enough load current (Tout). Therefore, feedback controller may generate a control signal and send to clock source 302 to increase the frequency of the clock signal to increase the load current. In another example, an optimum Vout for driving light source 206 or photodetector 216 may change with temperature (e.g., optimum Vout is proportional to k×Temperature, where k is a proportional coefficient). Temperature sensor 314 may sense the temperature in the environment around components of LiDAR 102, and provide the temperature data to feedback controller 310. Feedback controller 310 may then generate a control signal based on the temperature data and send to voltage source 304 to adjust Vdd according to the temperature data. In a further example, an optimum Vout for driving photodetector 216 may change with ambient light. Ambient light sensor 312 may be configured to sense an intensity of the ambient light in the operation environment and generate an ambient light intensity signal indicating the condition of the ambient light. Feedback controller may receive the ambient light intensity signal and generate a control signal. The control signal may be sent to voltage source 304 to adjust Vdd to achieve optimum Vout for biasing photodetector 216 according to the ambient light condition.

Although a Dickson voltage multiplier is shown as an exemplary implementation of voltage multiplier 306 in FIG. 4, voltage multiplier 306 is not limited to this example. Other types of voltage multipliers, charge pumps, or the like may also be used. For example, a half-wave series multiplier, also known as the Villard cascade, may be used. In another example, a Cockcroft-Walton voltage doubler, tripler, or similar circuits with more stages, may be used to implement voltage multiplier 306. In a further example, MOSFETs (e.g., wired as diodes) may be used to replace the diodes in the Dickson voltage multiplier shown in FIG. 4. In a further example, voltage multiplier 306 may be formed of a cascade of voltage doublers of the cross-coupled switched capacitor type for low Vdd applications (e.g., when Vdd is 1.2 V or less).

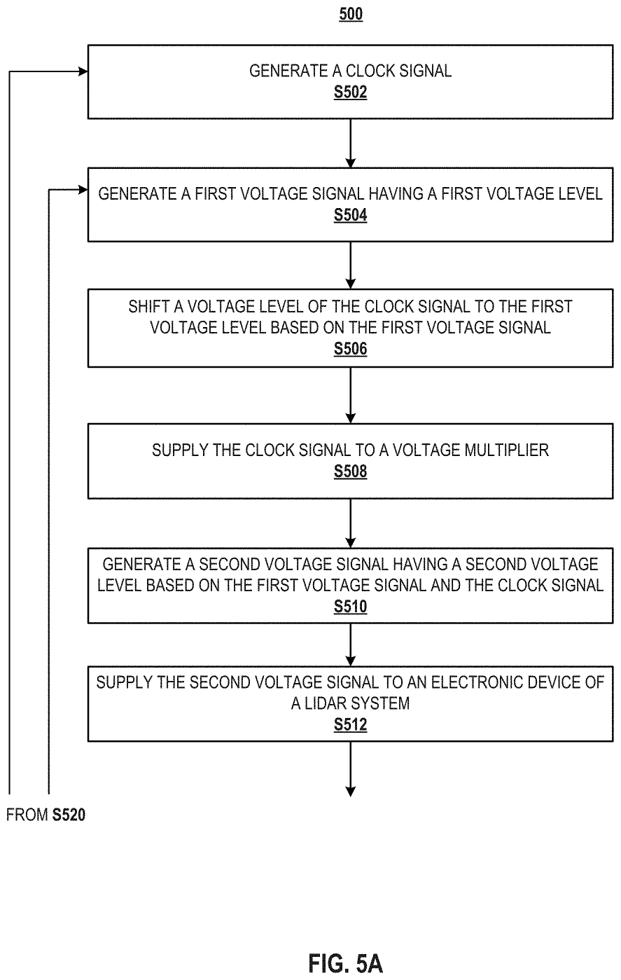

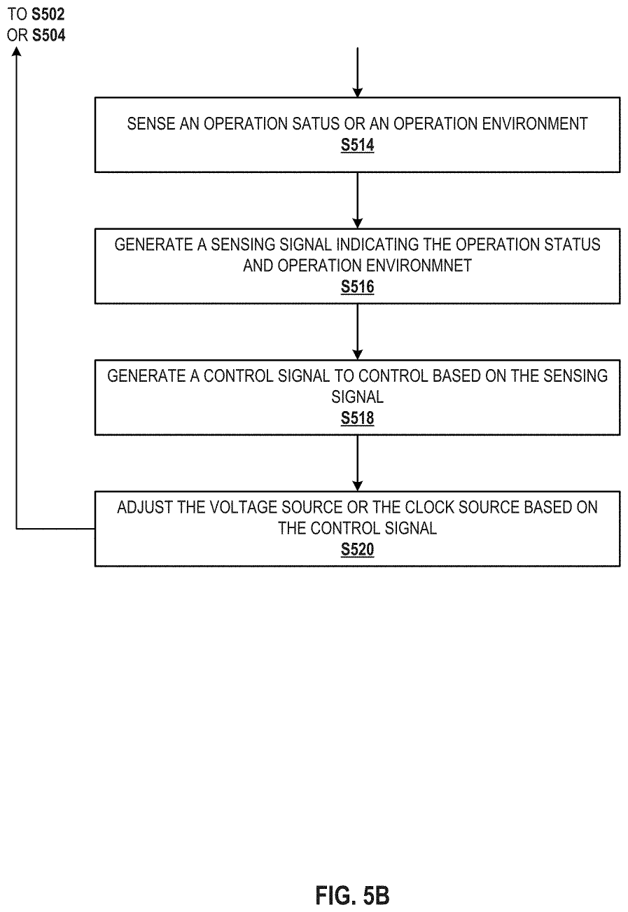

FIGS. 5A-5B show a flowchart of an exemplary method 500 for generating a voltage to power an electronic device of a LiDAR system, according to embodiments of the disclosure. For example, method 500 may be implemented by voltage generator 220 in FIGS. 2-4. However, method 500 is not limited to that exemplary embodiment. Method 500 may include steps S502-S520 as described below. It is to be appreciated that some of the steps may be optional to perform the disclosure provided herein. Further, some of the steps may be performed simultaneously, or in a different order than shown in FIGS. 5A-5B.

In step S502, clock source 302 may generate a clock signal. The clock signal may have a frequency f, a duty cycle τ, and an original voltage level. In some embodiments, the clock signal may be in the form of a pulse train, and each pulse may be a square wave, a sinusoidal wave, a triangular wave, or the like.

In step S504, voltage source 304 may generate a first voltage signal having a first voltage level. For example, the first voltage signal may be a DC voltage signal having a voltage level Vdd. Vdd may be used as the source voltage for inputting into voltage multiplier 306 and/or level shifter 308.

In step S506, voltage shifter 308 may shift the original voltage level of the clock signal generated by clock source 302 to the first voltage level (e.g., Vdd) based on the first voltage signal provided by voltage source 304. After the shifting, the clock signal may retain its frequency and/or duty cycle, while having its original voltage level adjusted to the first voltage level (e.g., Vdd).

In step S508, voltage shifter 308 may supply the clock signal 320 (after voltage level shifting) to voltage multiplier 306. The supplied clock signal 320 may be used to control the increasing or multiplication of source voltage Vdd by voltage multiplier 306.

In step S510, voltage multiplier 306 may generate a second voltage signal having a second voltage level based on the first voltage signal (e.g., Vdd) and clock signal 320. For example, voltage multiplier 306 may use various kind of voltage multiplication and/or charge pumping circuits to increase the source voltage level Vdd provided by voltage source 304. The voltage multiplication and/or charge pumping may be controlled by clock signal 320. In the example shown in FIG. 4, a Dickson voltage multiplier is used as an example, in which multiple stages of diode-capacitor pairs are used to alternately increase the voltage level along the stages. A non-overlapping pulse train generator 402 may be used to provide non-overlapping pulse trains 410 and 420 to operate the Dickson voltage multiplier.

In step S512, voltage multiplier 306 may supply the second voltage signal (e.g., output voltage Vout) to an electronic device (e.g., light source 206, scanner 210, photodetector 216, etc.) of LiDAR system 102. Depending on the requirements of the electronic device(s), individual electronic devices may be powered by separate voltage generators or multiple electronic devices may share a single voltage generator.

In step S514, one or more sensors (e.g., ambient light sensor 312, temperature sensor 314, voltage sensor 316, etc.) may sense an operation status or an operation environment of voltage generator 220. For example, ambient light sensor 312 may sense the intensity of the ambient light. In another example, temperature sensor 314 may sense the temperature in the environment of LiDAR system 102. In a further example, voltage sensor 316 may sense the ripples or noise in the output voltage Vout.

In step S516, the one or more sensors may generate a sensing signal indicating the operation status or the operation environment of the voltage generator and send the sensing signal to feedback controller 310. For example, ambient light sensor 312 may generate an ambient light intensity signal indicating the intensity of the ambient light. In another example, temperature sensor 314 may generate a temperature signal indicating the temperature in the environment of LiDAR system 102. In a further example, voltage sensor 316 may generate a signal indicating the level of ripples or noise in the output voltage Vout. Each of these sensing signals may be sent to feedback controller 310 for further processing.

In step S518, feedback controller 310 may generate a control signal based on the received sensing signal. For example, when the sensing signal indicates that the ambient light is low (e.g., at night time), feedback controller 310 may generate a control signal to control voltage source 304 such that Vdd is adjusted (resulting in the change of Vout) according to the low ambient light condition. In another example, when the sensing signal indicates that large ripples or noise is present in the output voltage, which may indicate that the output current is insufficient, feedback controller 310 may generate a control signal to control the frequency of the clock signal such that more charges are pumped to the output (e.g., by increasing the number of charging cycles per unit time). In a further example, when the sensing signal indicates that the temperature of light source 206 is high, feedback controller 310 may generate a control signal to control voltage source 304 such that a lower Vdd is provided to voltage multiplier 306, resulting in a lower output voltage Vout to drive light source 206.

In step S520, voltage source 304 and/or clock source 302 may adjust their outputs based on the control signal received from feedback controller 310 to close the feedback control loop. Method 500 may loop back to step S502 or S504, depending on which type of output is adjusted.

Embodiments of the present disclosure provide an improvement voltage generator 220 to generate high voltages using voltage multipliers or charge pumps. The improved voltage generator 220 can provide a stable DC output voltage based on a low-level source voltage (e.g., Vdd) and an alternating control signal (e.g. the clock signal). In this way, a low amplitude clock signal voltage is rectified to generate a high DC output voltage with passive unidirectional devices such as diodes. The clock signal can be provided by a programmable clock source 302 to achieve the optimum conversion efficiency for specific load conditions through frequency adjustment (e.g., adjusting clock signal frequency f). For a particular charge pump/voltage multiplier topology adopted to implement voltage multiplier 306 (e.g. a fixed architecture, the fixed number of elements, etc.), the voltage amplitude of the clock signal can also be adjusted (e.g., by adjusting Vdd) to generate different output voltage levels. No electromagnetic devices such as inductors or transformers are used, and no fast switcher devices such as switching ICs are used. As a result, the EMI generation and BOM (e.g. estimated <$5) are both much lower than the conventional approaches (e.g., shown in FIGS. 6 and 7).

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

1. A voltage generator for supplying voltage power to an electronic device of a Light Detection and Ranging (LiDAR) system, the voltage generator comprising:
a clock source configured to generate a clock signal;
a voltage source configured to generate a first voltage signal having a first voltage level; and
a voltage multiplier coupled to the voltage source and the clock source, the voltage multiplier being configured to generate a second voltage signal having a second voltage level based on the first voltage signal and the clock signal, wherein the second voltage level is higher than the first voltage level.

2. The voltage generator of claim 1, comprising:
a level shifter coupled to the clock source and the voltage source, the level shifter being configured to shift a voltage level of the clock signal to the first voltage level based on the first voltage signal.

3. The voltage generator of claim 2, wherein the level shifter is coupled to the voltage multiplier and configured to supply the clock signal having the voltage level shifted to the first voltage level to the voltage multiplier to generate the second voltage signal.

4. The voltage generator of claim 2, wherein:
the clock signal comprises a plurality of pulses; and
the level shifter is configured to shift a height of the plurality of pulses to the first voltage level.

5. The voltage generator of claim 1, wherein the voltage multiplier comprises a Dickson voltage multiplier having multiple stages, each stage comprising a diode and a capacitor.

6. The voltage generator of claim 5, comprising a non-overlapping pulse train generator configured to:
generate first and second pulse trains based on the clock signal, wherein pulses of the first and second pulse trains are non-overlapping; and
supply the first and second pulse trains to the Dickson voltage multiplier.

7. The voltage generator of claim 1, wherein the voltage multiplier is configured to generate the second voltage signal without using an inductor or a transformer.

8. The voltage generator of claim 1, comprising:
one or more sensors configured to sense an operation status or an operation environment of the voltage generator and generate a sensing signal; and
a feedback controller configured to receive the sensing signal and generate a control signal to control the voltage source or the clock source based on the sensing signal.

9. The voltage generator of claim 8, wherein the one or more sensors comprise at least one of:
a temperature sensor configured to sense a temperature in the operation environment;
a voltage sensor configured to sense a ripple or noise in the second voltage signal; or
an ambient light sensor configured to sense an intensity of ambient light in the operation environment.

10. The voltage generator of claim 1, wherein at least one of the clock source or the voltage source is programmable to generate the clock signal having a programmable frequency or the first voltage signal having a programmable first voltage level.

11. A method for generating a voltage to power an electronic device of a Light Detection and Ranging (LiDAR) system, comprising:
generating, by a clock source, a clock signal;
generating, by a voltage source, a first voltage signal having a first voltage level; and
generating, by a voltage multiplier, a second voltage signal having a second voltage level based on the first voltage signal and the clock signal, wherein the second voltage level is higher than the first voltage level.

12. The method of claim 11, comprising:
shifting, by a level shifter, a voltage level of the clock signal to the first voltage level based on the first voltage signal; and
supplying, by the level shifter, the clock signal having the voltage level shifted to the first voltage level to the voltage multiplier to generate the second voltage signal.

13. The method of claim 12, wherein shifting the voltage level of the clock signal comprises:
shifting a height of a plurality of pulses of the clock signal to the first voltage level.

14. The method of claim 11, wherein the voltage multiplier comprises a Dickson voltage multiplier having multiple stages, each stage comprising a diode and a capacitor.

15. The method of claim 14, comprising:
generating, by a non-overlapping pulse train generator, first and second pulse trains based on the clock signal, wherein pulses of the first and second pulse trains are non-overlapping; and
supplying, by the non-overlapping pulse train generator, the first and second pulse trains to the Dickson voltage multiplier.

16. The method of claim 11, comprising:
generating the second voltage signal without using an inductor or a transformer.

17. The method of claim 11, comprising:
sensing, by one or more sensors, an operation status or an operation environment of the voltage generator;
generating, by the one or more sensors, a sensing signal indicating the operation status or the operation environment of the voltage generator;
receiving, by a feedback controller, the sensing signal; and
generating, by the feedback controller, a control signal to control the voltage source or the clock source based on the sensing signal.

18. The method of claim 11, wherein sensing the operation status or the operation environment of the voltage generator comprises at least one of:
sensing a temperature in the operation environment;
sensing a ripple or noise in the second voltage signal; or
sensing an intensity of ambient light in the operation environment.

19. A Light Detection and Ranging (LiDAR) system, comprising:
a light source configured to emit a light beam;
a scanner configured to project the light beam to an object;
a photodetector configured to detect a reflected light beam reflected from the object; and
a voltage generator configured to supply a voltage to at least one of the light source, the scanner, or the photodetector, the voltage generator comprising:
a clock source configured to generate a clock signal;
a voltage source configured to generate a first voltage signal having a first voltage level; and
a voltage multiplier coupled to the voltage source and the clock source, the voltage multiplier being configured to:
generate a second voltage signal having a second voltage level based on the first voltage signal and the clock signal, wherein the second voltage level is higher than the first voltage level; and
supply the second voltage signal to at least one of the light source, the scanner, or the photodetector.

20. The LiDAR system of claim 19, wherein the voltage generator comprises:
a level shifter coupled to the clock source, the voltage source, and the voltage multiplier, the level shifter being configured to:
shift a voltage level of the clock signal to the first voltage level based on the first voltage signal; and
supply the clock signal having the voltage level shifted to the first voltage level to the voltage multiplier to generate the second voltage signal.
